(19) United States
(12) Patent Application Publication
(10) Pub. No.: US 2003/0008096 A1
(43) Pub. Date: Jan. 9, 2003

(54) Decorative magnetic facing materials

(76) Inventor: Monica Benitz, Annapolis, MD (US)

Correspondence Address: ROYAL W. CRAIG, SUITE 153, 10 NORTH CALVERT STREET, BALTIMORE, MD, 21202, US

(21) Appl. No.: 10/187,313

(22) Filed: Jun. 28, 2002

Related U.S. Application Data
(60) Provisional application No. 60/301,577, filed on Jun. 28, 2001.

(51) Int. Cl. B32B 3/10

(52) U.S. Cl. 428/44

(57) ABSTRACT

An applique system for decorative magnetic facing materials, fabricated from thin sheets of flexible, vinyl-coated, magnetic material, for removable attachment to the exterior, magnet-attracting surfaces found in home (washers, dryers, refrigerators, dishwashers, ovens) and office (filing/storage cabinets, restroom stall doors) environments is herein disclosed. The decorative magnetic facing materials provide a simple, economical, user-configurable means to integrate the generically colored, magnet-attracting surfaces found in home and office environments with specific interior decorative schemes/themes. The decorative magnetic facing materials incorporate geometric and non-geometric designs that can be used in horizontal or vertical oreintations and that facilitate precise cutting into user-configured shapes/sizes. The decorative magnetic facing materials are simple to apply/remove and economical to produce/purchase, thereby allowing a user to change the appearance of magnet-attracting surfaces as frequently as desired.

### CROSS-REFERENCED TO RELATED APPLICATIONS

The present application derives priority from U.S. Provisional Patent Application No. 60/301,577; filed Jun. 28, 2001.

### BACKGROUND OF THE INVENTION

1. Field of the Invention

The present invention relates to decorative materials and, more particularly, to an applique system of ornamental facing materials designed for removable attachment to the exterior, magnet-attracting surfaces found in home (e.g. washers, dryers, refrigerators, dishwashers, ovens) and office (e.g. filing/storage cabinets, restroom stall doors) environments.

2. Description of the Background

The decoration of the interior of one's living and/or work space can be an important, and very satisfying, means of self-expression. In the world of the 21^{st} Century, a significant portion of one's living space is often occupied by modem conveniences (many would say “necessities”) such as major appliances. Traditionally, these major appliances (e.g. refrigerators, dishwashers, washers, dryers, ovens) have only been available in an extremely limited range of colors. This reality has imposed severe limitations on those looking to integrate one or more appliances with specific interior color schemes or style themes. While the manufacturers of these items now offer a wider range of colors, the current offerings are still inadequate with respect to the needs of many professional, and amateur, interior decorators.

This is not an entirely new dilemma. U.S. Pat. Nos. 2,293,887 to Chamberlin, 3,124,501 to Wise, 5,496,104 to Arnold et al., 5,806,942 to Jenkins, Jr. et al., 5,549,938 to Nesbitt, and 5,931,522 to Roskey each provide means to adapt the generic appearance of household appliances, or other large objects/flat surfaces, to an individual's specific requirements. Chamberlain '887 discloses decorative sheet material that is attached to a surface using its ability to retain an electrostatic charge. Wise '501 discloses ornamental facings designed for attachment to appliances via a series of magnets positioned along the edges of the facings. Arnold et al. '104 discloses an apparatus for attaching a decorative door to the front of an existing appliance. The means for anchoring the door's hinge to the appliance is a series of rubber-faced magnets. Jenkins, Jr. et al. '942 discloses a dishwasher door/panel assembly designed to hold a decorative panel between two vertical flanges. Nesbitt '938 discloses removable camouflage and Roskey '522 discloses a body protection apparatus, both are designed for attachment to the exterior of motor vehicles. The Nesbitt '938 and Roskey '522 devices are fabricated from thin sheets of flexible, magnetic material.

While the above-referenced U.S. patents demonstrate that the basic concept of utilizing some sort of covering to adapt a generically colored surface to a more specific need is well known, they fall short, individually and/or in combination, of the solution provided by the present invention in one or more respects. The Chamberlain '887 invention makes use of nonmagnetic, electrostatically-chargeable plastic sheeting. It is not fabricated from thin sheets of flexible, magnetic material. Instead, electrostatic energy (i.e. static electricity) is used to adhere the sheet to the underlying surface. The Wise '501 invention is a one-piece, ornamental facing attached to a surface via a series of magnets positioned along its edges. It is not fabricated from thin sheets of flexible, magnetic material, nor is it designed to, when necessary, be cut into smaller, user-configurable shapes and sizes (i.e. the unitary nature of the picture/pattern on the facing would be lost). The Arnold et al. '104 and Jenkins, Jr. et al. '942 inventions are complete door assemblies designed for use on household appliances (specific to dishwashers in the case of Jenkins). They are, again, not fabricated from thin sheets of flexible, magnetic material, nor designed for manipulation into smaller, user-configured shapes and sizes. Finally, while the Nesbitt '938 and Roskey '522 inventions are fabricated from thin sheets of flexible, magnetic material, their uses are specific to motor vehicles and any patterns that they incorporate are not designed to maintain a consistent look when cut into smaller pieces.

Therefore, it would be greatly advantageous to provide a simple, economical, user-configurable means to integrate the generically colored, magnet-attracting surfaces found in home and work environments with specific interior decorative schemes/themes.

### SUMMARY OF THE INVENTION

It is, therefore, an object of the present invention to provide decorative magnetic facing materials designed for removable attachment to the exterior, generically-colored, magnet-attracting surfaces found in home and work environments (e.g. washers, dryers, refrigerators, dishwashers, filing/storage cabinets).

It is another object of the present invention to provide decorative, multi-layered, magnetic facing materials that include at least one flexible, magnetic layer.

It is still another object of the present invention to provide decorative magnetic facing materials that can be cut into smaller, user-configured shapes and sizes.

It is a further object of the present invention to provide an applique system of decorative magnetic facing materials incorporating geometric patterns that maintain pattern uniformity when cut into smaller, user-configured shapes and sizes.

It is another object of the present invention to provide an applique system of decorative magnetic facing materials incorporating central areas having geometric patterns and separate borders that, when used in conjunction with central areas, compliment the central areas regardless of cut.

It is another object of the present invention to provide decorative magnetic facing materials that are stain resistant.

It is still another object of the present invention to provide decorative magnetic facing materials that are simple to apply/remove and economical to produce/purchase.

According to the present invention, the above-described and other objects are accomplished by providing an applique system comprised of decorative, multi-layered, magnetic facing materials that include at least one vinyl layer, at least one layer containing the decorative pattern, and at least one flexible, magnetic layer. The decorative magnetic facing materials incorporate geometric and non-geometric designs that can be used in horizontal or vertical positions and that facilitate precise cutting into user-configured shapes/sizes. The decorative magnetic facing materials are simple to apply/remove and economical to produce/purchase, thereby allowing a user to change the appearance of magnet-attracting surfaces as frequently as desired. The applique system includes two types of facing material sections: 1) central areas having geometric patterns, and 2) separate borders that, when used in conjunction with central areas, complement the central areas regardless of dimensions and/or cut.

### BRIEF DESCRIPTION OF THE DRAWINGS

Other objects, features, and advantages of the present invention will become more apparent from the following detailed description of the preferred embodiment and certain modifications thereof when taken together with the accompanying drawings in which:

FIG. 1 is a perspective view of the decorative magnetic facing material 10 according to a first embodiment of the present invention, showing an exemplary geometric pattern.

FIG. 2 is a perspective view of the decorative magnetic facing material 12 according to a second embodiment of the present invention, showing an exemplary, multi-directional pattern.

FIG. 3 shows an exemplary use of the applique system of the present invention, inclusive of both facing material sections: 1) a central area 10 having a geometric pattern, and 2) a separate border 12 that compliments the cental area 10. The system of magnetic facing materials 10, 12 is applied to the door of a typical refrigerator 20.

FIG. 4 is a cross-sectional view of the decorative magnetic facing material 10, 12 according to a first embodiment of the present invention.

### DETAILED DESCRIPTION OF THE PREFERRED EMBODIMENTS

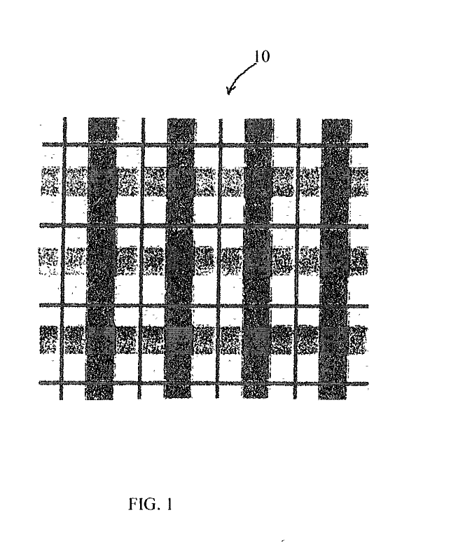

FIG. 1 is a perspective view of a central section of the decorative magnetic facing material 10 according to a first embodiment of the present invention, showing an exemplary geometric pattern. The decorative magnetic facing material 10 is preferably supplied in sheets measuring 24″ wide×66″ tall.

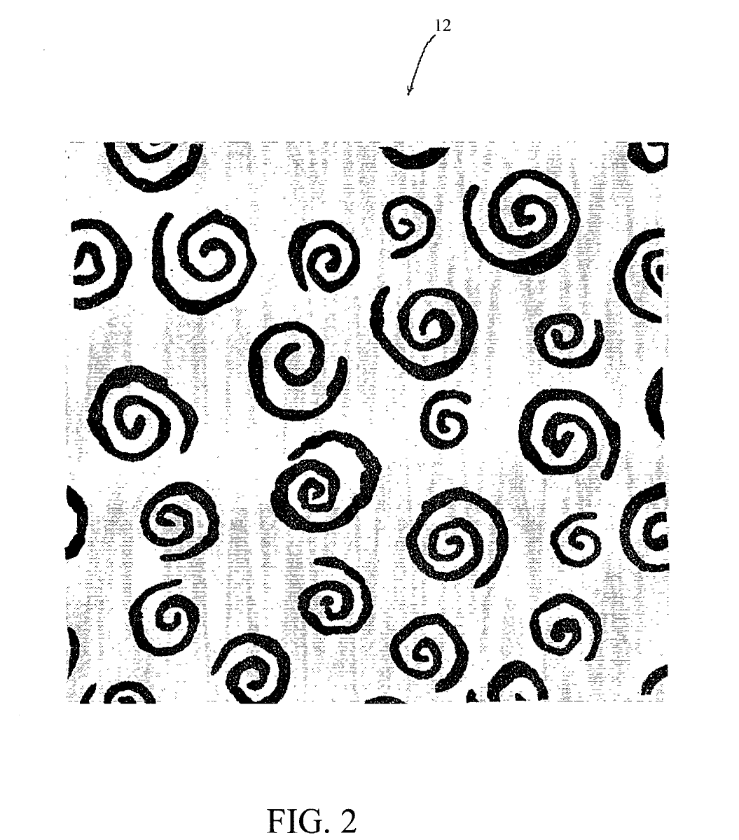

FIG. 2 is a perspective view of a border section of the decorative magnetic facing material 12 according to a second embodiment of the present invention, showing an exemplary multi-directional, non-geometric pattern. The decorative magnetic facing material 12 is preferably supplied in border strips measuring up to 200″ in length with a width of 4″. While the patterns utilized on the border strips are typically non-geometric, alternative embodiments do include geometric patterns.

In the case of both facing sections 10, 12, the dimensions of the sheets and border strips are not fixed and can vary from those mentioned above. It is the nature and configuration of the decorative patterns on the sheets and border strips that is important, not their physical dimensions. More specifically, the decorative magnetic sheets 10 are preferably provided with small geometric patterns in which the pattern elements are repeated at intervals of no more than 2″. The border strips 12 are preferably provided with a variety of typically non-geometric patterns or solid colors. Both are supplied in a plurality of color combinations. The patterns applied to the sheets 10 and the border strips 12 are multi-directional in nature such that they may be utilized in either a vertical or horizontal orientation to suit the needs of the user. This is of particular importance with respect to the border strips 12 which, when used to compliment a central sheet 10, must be capable of installation along either a vertical or horizontal edge of that sheet 10.

The novel geometric and non-geometric patterns incorporated on the facing materials 10, 12 are chosen for two reasons. First, the patterns facilitate the precise cutting of the sheets 10 to fit any generically colored, magnet-attracting surface (i.e. the spacing between the lines of a typical pattern are such that cutting directly along one or more of the lines will result in a facing sheet possessing an appropriate shape/size for the surface to be covered). Second, and more importantly, the patterns are chosen for their scalability. The novel use of scalable patterns ensures that the facing materials can be cut to any required shape/size and still retain a “look,” or overall appearance, that is consistent from one decorative facing installation to the next, as well as remaining consistent with the surrounding interior decoration scheme/theme.

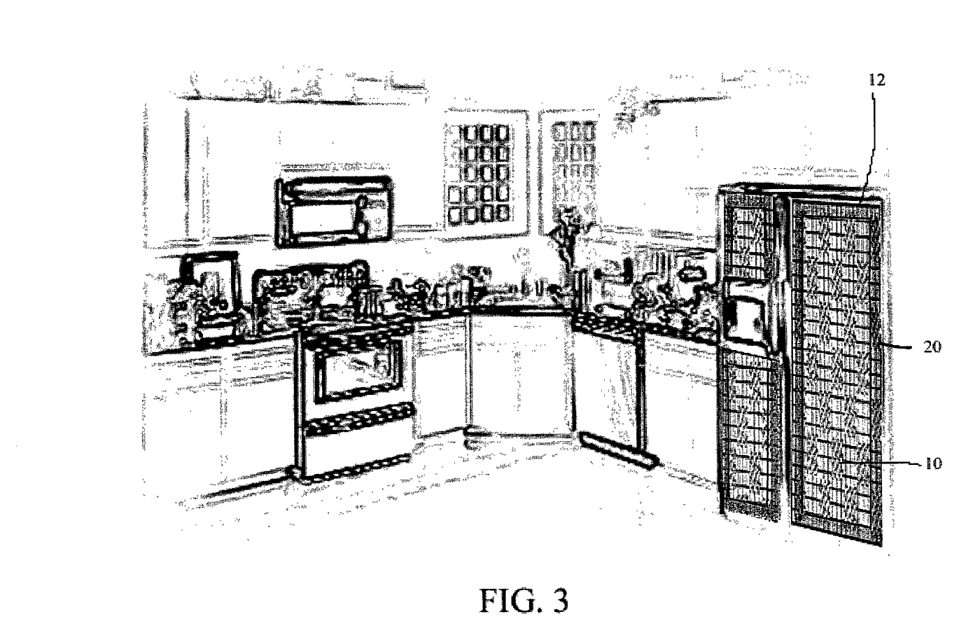

FIG. 3 shows the applique system of the present invention, inclusive of both facing material sections pre-cut to specifications: 1) a central area 10 having a geometric pattern, and 2) a separate border 12 that compliments the central area 10. The system of magnetic facing materials 10, 12 is applied to the door of a typical refrigerator 20. Alternative installations may utilize a pre-cut central area 10 only (i.e. without a border 12), or border material 12 only (i.e. without a central area 10).

The sheet material 10 may be utilized to cover the majority of any generically colored, magnet-attracting surface. The border strip material 12 is used at the top, bottom, and both sides of the sheet 10 to complete the decorative facing. Therefore, as an example, the maximum combined dimensions of a sheet 10 and border strip 12 application, according to the dimensions specified above, are 32″ wide×74″ tall—typically more than sufficient to cover any exterior surface of any household appliance or office cabinet. Configuring the materials 10, 12 to any size surface is easily accomplished because the sheets 10 and border strips 12 are readily cut with any standard scissors.

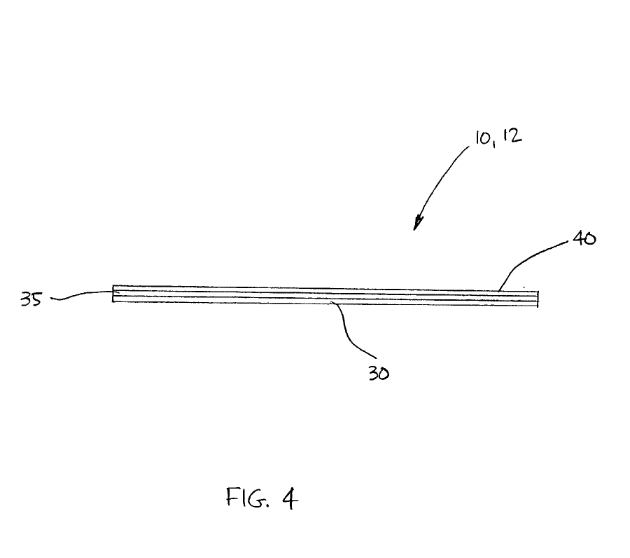

FIG. 4 is a cross-sectional view of the decorative magnetic facing material 10, 12 according to a first embodiment of the present invention. The multi-layered construction typically includes a bottom layer of flexible, magnetic material 30, a middle layer of vinyl 35, and a top layer comprising an aforementioned design or pattern 40 imprinted directly on the layer of vinyl 35. The magnetic material 30 is preferably a thermoplastic permanent magnet material (e.g. ULTRA-MAG flexible magnetic sheeting from Flexmag Industries, Inc. of Marietta, Ohio) possessing multi-magnetic polarization to optimize its holding force on magnet-attracting surfaces. The layer of vinyl 35 provides the present invention with an easily-cleaned, stain-resistant surface.

An alternative manufacturing technique for the decorative magnetic facing materials provides for the printing of one of the aforementioned designs/patterns on paper stock (e.g. similar to wallpaper, shelf paper) prior to lamination between a bottom layer of magnetic material and a top layer of vinyl.

Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

I claim:

1. A decorative magnetic facing material, comprising:
a first layer of flexible magnetic material;
a second layer of vinyl laminated to said first layer of magnetic material; and
a third layer of ink printed in the form of a decorative, scalable pattern directly on said second layer of vinyl;
wherein said three layers form a flexible, laminated, multi-layered, decoratively patterned, magnetic material.

2. The decorative magnetic facing material according to claim 1, wherein said decorative, scalable pattern is multi-directional.

3. The decorative magnetic facing material according to claim 2, wherein said decorative, scalable pattern facilitates precise configuration of said magnetic facing material into a user-defined shape and size.

4. The decorative magnetic facing material according to claim 3, wherein said decorative, scalable pattern, regardless of said user-defined shape and size of said magnetic facing material, maintains an aesthetically pleasing, consistent “look” or appearance.

5. The decorative magnetic facing material according to claim 4, wherein said decorative, scalable pattern is geometric.

6. The decorative magnetic facing material according to claim 4, wherein said decorative, scalable pattern is non-geometric.

7. A decorative magnetic facing material, comprising:
a first layer of flexible, magnetic material;
a second layer of paper stock imprinted with a decorative, scalable pattern; and
a third layer of vinyl material;
wherein said three layers form a flexible, laminated, multi-layered, decoratively patterned, magnetic material.

8. The decorative magnetic facing material according to claim 7, wherein said decorative, scalable pattern is multi-directional.

9. The decorative magnetic facing material according to claim 8, wherein said decorative, scalable pattern facilitates precise configuration of said magnetic facing material into a user-defined shape and size.

10. The decorative magnetic facing material according to claim 9, wherein said decorative, scalable pattern, regardless of said user-defined shape and size of said magnetic facing material, maintains an aesthetically pleasing, consistent “look” or appearance.

11. The decorative magnetic facing material according to claim 10, wherein said decorative, scalable pattern is geometric.

12. The decorative magnetic facing material according to claim 10, wherein said decorative, scalable pattern is non-geometric.

13. An applique system for magnetic surfaces, comprising:
a first sheet of flexible, laminated, multi-layered, magnetic material having a decorative, scalable pattern, said first sheet of magnetic material being configured according to user-defined parameters;
a second sheet of flexible, laminated, multi-layered, magnetic material having a decorative, scalable pattern, said second sheet of magnetic material being configured into one or more sections according to user-defined parameters;
wherein attachment to a magnetic surface of said user-defined first sheet and said user-defined one or more sections configured from said second sheet creates an aesthetically pleasing, decorative cover for said magnetic surface.

14. The applique system for magnetic surfaces according to claim 13 wherein said one or more user-defined sections configured from said second sheet are attached to said magnetic surface proximate one or more edges of said user-defined first sheet.

15. The applique system for magnetic surfaces according to claim 13, wherein said decorative, scalable patterns on said first and said second sheets are multi-directional.

16. The applique system for magnetic surfaces according to claim 15, wherein said decorative, scalable patterns on said first and said second sheets facilitate precise configuration of said sheets into user-defined shapes and sizes.

17. The applique system for magnetic surfaces according to claim 16, wherein said decorative, scalable patterns on said first and said second sheets, regardless of said user-defined shapes and sizes, maintains an aesthetically pleasing, consistent “look” or appearance.

18. The applique system for magnetic surfaces according to claim 17, wherein said decorative, scalable pattern on said first sheet is geometric.

19. The applique system for magnetic surfaces according to claim 17, wherein said decorative, scalable pattern on said second sheet is non-geometric.

20. A method for decorating generically-colored, magnetic surfaces comprising the steps of:
cutting a first sheet of flexible, laminated, multi-layered, decoratively patterned, magnetic material to a user-defined shape and size;
cutting a second sheet of flexible, laminated, multi-layered, decoratively patterned, magnetic material into one or more sections, each of said sections having a user-defined shape and size;
installing said user-defined first sheet on a magnetic surface; and
installing said one or more user-defined sections on said magnetic surface proximate one or more edges of said first sheet;
wherein an aesthetically pleasing, decorative cover for said magnetic surface is created.
